(19) United States
(12) Patent Application Publication
(10) Pub. No.: US 2017/0260341 A1
(43) Pub. Date: Sep. 14, 2017

(54) CATIONIC ULTRAVIOLET CURING OF RESINS WITH ONIUM SALT

(71) Applicant: Case Western Reserve University, Cleveland, OH (US)

(72) Inventors: Anne Walker, Cleveland, OH (US); Gary E. Wnek, Cleveland, OH (US)

(73) Assignee: Case Western Reserve University, Cleveland, OH (US)

(21) Appl. No.: 15/457,969

(22) Filed: Mar. 13, 2017

Related U.S. Application Data
(60) Provisional application No. 62/306,854, filed on Mar. 11, 2016.

(51) Int. Cl. C08J 3/24; C09D 109/02; C09D 183/06

(52) U.S. Cl. CPC C08J 3/24; C09D 183/06; C09D 109/02; B33Y 70/00

(57) ABSTRACT

Disclosed herein is a method of forming a photocurable polymer system. The method includes providing a polymer, providing a diaryl iodonium salt, blending said polymer and diaryl iodonium salt, applying the blend to a substrate; and crosslinking the blend. The polymer can be a silicone-based polymer, such as PDMS-ECHE. The polymer can also be ETBN. The blend can be crosslinked by exposing the blend to ultraviolet light, and the crosslinking can be cationic crosslinking. In one example, the wavelength of the ultraviolet light is 254 nm. The blend can be exposed to ultraviolet light for between about 10 seconds and 90 seconds. In one example, the blend is two percent by weight of the diaryl iodonium salt to the polymer.

### RELATED APPLICATION

This application claims priority to U.S. Provisional Patent Application Ser. No. 62/306,854, titled “Cationic Ultraviolet Curing of Resins with Onium Salt,” which was filed on Mar. 11, 2016, which is expressly incorporated by reference herein in its entirety.

### FIELD OF INVENTION

The present disclosure is generally directed to photocurable polymer system, and specifically directed to photocuring a polymer for use as a coating on a substrate for protecting the substrate.

### BACKGROUND

Industrial production methods and processes are continuously scrutinized in search of improvements and greater efficiency. One area of scrutiny is developments of new processes or refinements of existing processes that yield savings in time and energy consumption. Such scrutiny applies to industrial production methods that incorporate chemical processes. One area of potential gains in efficiency in chemical processes is to seek alternatives to heating processes that take considerable time to perform and use relatively high amounts of energy. One approach to such a problem is to seek alternative chemistries that yield comparable or improved results, while reducing the amount of time required to achieve such results and reducing the amount of energy required to accomplish the process.

### SUMMARY

Disclosed herein is a method of forming a photocurable polymer system. The method includes providing a polymer, providing a diaryl iodonium salt, blending said polymer and diaryl iodonium salt, applying the blend to a substrate; and crosslinking the blend. The polymer can be a silicone-based polymer, such as PDMS-ECHE. The polymer can also be ETBN. The blend can be crosslinked by exposing the blend to ultraviolet light, and the crosslinking can be cationic crosslinking. In one example, the wavelength of the ultraviolet light is 254 nm. The blend can exposed to ultraviolet light for between about 10 seconds and 90 seconds. In one example, the blend is two percent by weight of the diaryl iodonium salt to the polymer.

### BRIEF DESCRIPTION OF THE DRAWINGS

Objects and advantages together with the operation of the invention may be better understood by reference to the detailed description taken in connection with the following illustrations, wherein:

FIG. 1 is a schematic illustration of a photocuring process.

FIG. 2 illustrates a diaryl iodonium salt structure.

FIG. 3 illustrates a Poly[dimethylsiloxane-co-(2-(3,4-epoxycyclohexyl)ethyl) methylsiloxane] structure.

FIG. 4 is a series of photographs depicting samples that were exposed to UV light for 20 seconds (leftmost photograph), 30 seconds (center photograph), and 40 seconds (rightmost photograph).

FIG. 5 includes photographs depicting a coated glass bottle (displayed on the left) and an uncoated glass bottle (displayed on the right).

FIG. 6 are photographs depicting a coated bottle post the application of the blunt force.

FIG. 7 is a photograph depicting an uncoated bottle post the application of a blunt force.

FIG. 8 are photographs of 2 mL test samples with curing times ranging from 20 seconds to 60 seconds.

FIG. 9 are photographs of .25 mL test samples with curing times ranging from 20 seconds to 90 seconds.

FIG. 10 are photographs of 0.1 mL test samples with curing times ranging from 20 seconds to 90 seconds.

FIG. 11 is a graph depicting the stress-strain relationship for 0.1 mL samples cured for 40 seconds and 60 seconds.

FIG. 12 is chart depicting test results based on cure time and volume of samples.

FIG. 13 are photographs illustrating the results of testing on coated and uncoated light bulbs.

### DETAILED DESCRIPTION

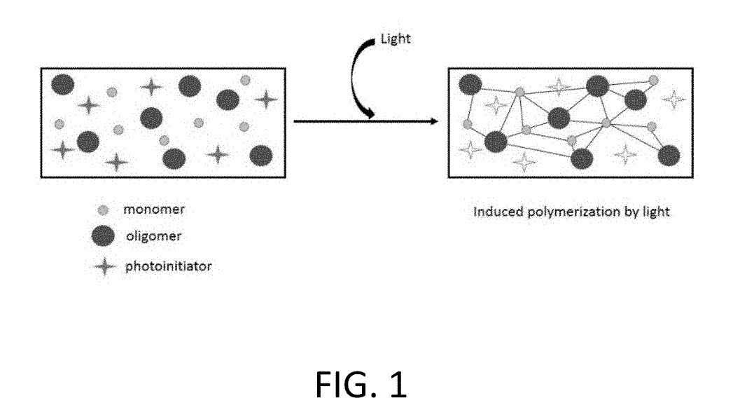

The systems and methods disclosed in this document are described in detail by way of examples and with reference to the figures. It will be appreciated that modifications to disclosed and described examples, arrangements, configurations, components, elements, systems, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be and should not be construed as mandatory or limiting unless specifically designated as such. Selected examples of photocurable polymer systems are hereinafter disclosed and described in detail with reference made to FIGS. 1-13.

Exemplary methods and systems described herein include improvements to the efficiency of polymer coating processes that typically rely on the thermal curing by introducing novel materials and processes for ultra-violet (“UV”) curable resins that can be spread onto a surface and rapidly cured. UV crosslinking systems can take as little as a few seconds to cure, improving both the energy efficiency and processing time for industrial coating processes. In one exemplary method, cationic crosslinking systems can serve as a replacement for inefficient industrial coating processes. Cationic crosslinking systems can be processed at room temperature without the need for inert atmosphere. The process is illustrated schematically in FIG. 1. A monomer, oligomer, and photoinitiator are blended and exposed to UV light at room temperature to induce polymerization.

When such processes are used to coat objects, such as glass objects, the coatings can be low-viscosity, reactive silicones that are rapidly cured with UV light at room temperature. Thus, replacing processes that rely on thermal curing, in the range of 200 degrees Celsius for crosslinking rubber. Additional advantages of this approach include the ability to uniformly coat irregular surfaces, and to create multi-layer films of different properties and thicknesses (e.g., a low-tack and/or abrasion-resistant outer layer). Photocure compositions that are versatile and tunable can also be used for custom coatings and adhesives and photocure-based additive manufacturing.

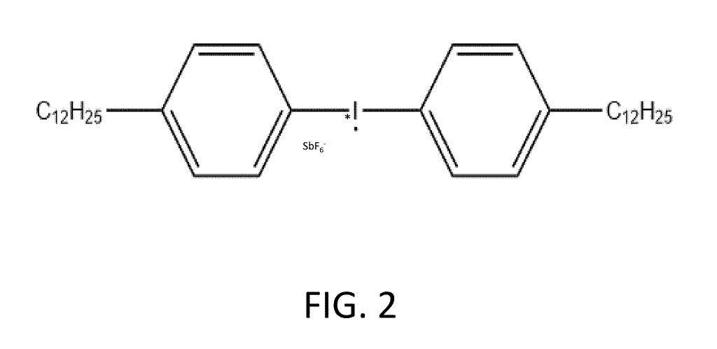

In one example, a cationic photo-curing system can rely on diaryl iodonium salts blended with polymers with reactive side groups, such as epoxies or vinyl ethers, which, when exposed to shortwave (in the range of approximately 250 nm) UV light undergo a crosslinking reaction. Such a system can also be blended with a photosensitizer like curcumin, allowing the polymerization and crosslinking reaction to proceed upon exposure to visible light. Such a diaryl iodonium salt structure is illustrated in FIG. 2. Such salt structures can be used, for example, with epoxy-modified silicones.

In one exemplary method and system, coatings, such as elastomeric coatings, can provide the underlying coated material with the ability to absorb a mechanical impact and limit or prevent damage to the underlying material. For example, an elastomeric coating applied to a glass container or light bulb can prevent a catastrophic breakage of an underlying material when the glass container or light bulb is subjected to a mechanical impact. For a material to achieve elastomeric properties, generally speaking, the material: (1) can be a substantially to completely amorphous polymer; (2) with light crosslinking, which can be via primary covalent bonds or through physical crosslinking; and (3) can have a use temperature that is above the glass transition temperature of the crosslinked polymer.

Disclosed herein is a novel method for forming a material that is rubber-like with energy-absorbing properties. The method includes light-initiated crosslinking of a material by controlling the UV exposure time. Once such a material is appropriately crosslinked, the material can be applied to a substrate to protect the substrate. For example, the crosslinked material can be applied to coat a glass bottle to protect the bottle against mechanical impact.

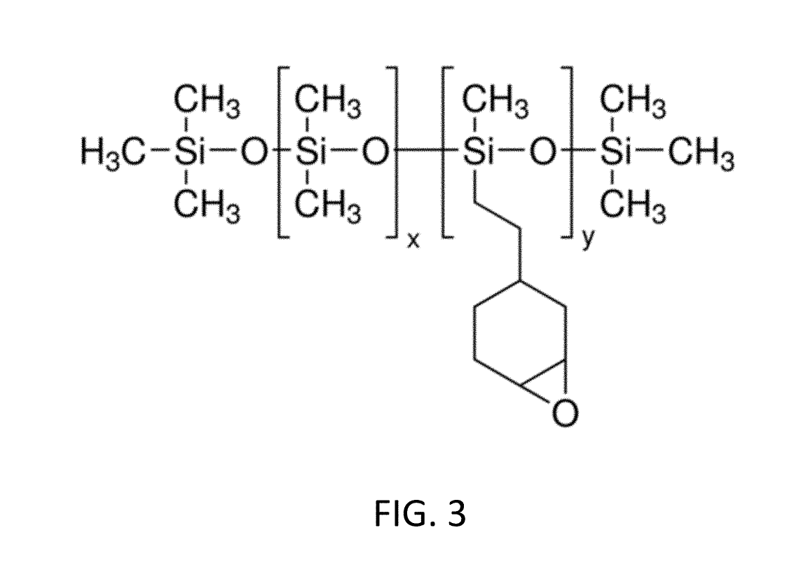

In one example, materials used to prepare an elastomeric coating include Poly [dimethyl siloxane-co-(2-(3 ,4-epoxycyclohexyl)ethyl)methyl siloxane] (“PDMS-ECHE”) and a cationic photocatalyst, such as for example Photocompound 1467 (“PC 1467”). The structure of PDMS-ECHE is illustrated in FIG. 3. In one example, the PDMS-ECHE can serve as a resin and can be acquired from Sigma Aldrich, and PC 1467 can serve as a curing agent and can be acquired from Evonik Industries. PDMS-ECHE is a clear, viscous liquid, which becomes opaque upon mixing with the curing agent. The viscosity of the material is such that it can be collected using a micropipetter or a syringe then deposited on a surface and cured without excess flow or generation of uneven thick on thin regions. PC 1467 is a commercially-available, solvent-free iodonium salt solution that does not require inert gas atmosphere or post-processing solvent removal.

To demonstrate the capabilities of the above described materials, glass slides, cylindrical glass vials, and light bulbs were all coated and tested. Solutions of 2% by weight of PC 1467 and PDMS-ECHE were mixed and spread onto a glass slide, then exposed to a 254 nm mercury arc lamp. Samples were placed three inches from the lamp and exposed for varying amounts of time. Initial experimentation focused on assessing the effectiveness of the photocrosslinking reaction and quality of the cured material (brittleness, scratch resistance, optical clarity, etc.) while further experimentation focused on coatings of increasing thickness and the resultant degree of curing, peelability, dryness once peeled, and tackiness.

In initial experimentation, samples were tested in 10 second increments. Fifty microliters of resin/crosslinker solution was deposited onto glass slides and spread across a 1 inch by 1 inch area. Results are summarized in the Table 1 below.

TABLE 1

| Time (sec) | Observations |
|---|---|
| 10 | No material change |
| 20 | Some curing, skin formation |
| 30 | More curing, material can be peeled and remains |
| | elastic, but still feels “wet” and tacky |
| 40 | Mostly cured, less “wet” and no tack |

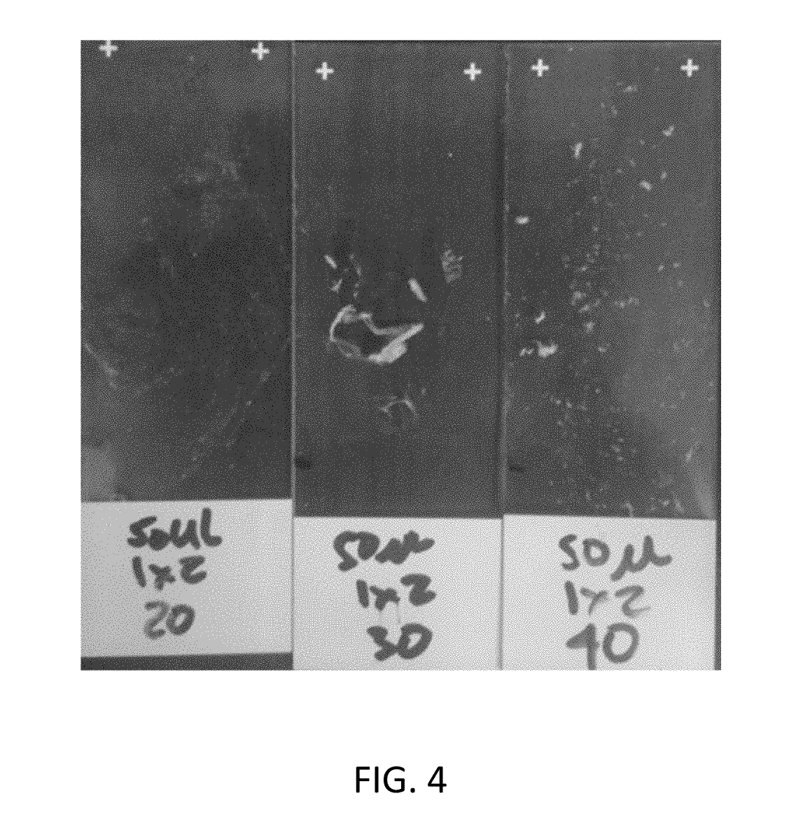

Based on the results from the table, further experimentation was conducted on samples exposed to UV light for 20 seconds or more. It was observed that a skin formed on the top of the materials, leaving wet, uncured sample behind. FIG. 4 is a comparison of samples exposed to UV light for 20 seconds (leftmost photograph), 30 seconds (center photograph), and 40 seconds (rightmost photograph). When tested on flat glass microscope slides: for samples cured for 20 seconds, no curing was observed; for samples cured for 30 seconds, the material cured and could be peeled off in intact sheets; for samples cured for 40 seconds, the material could be rubbed off but came away in small flakes rather than sheets.

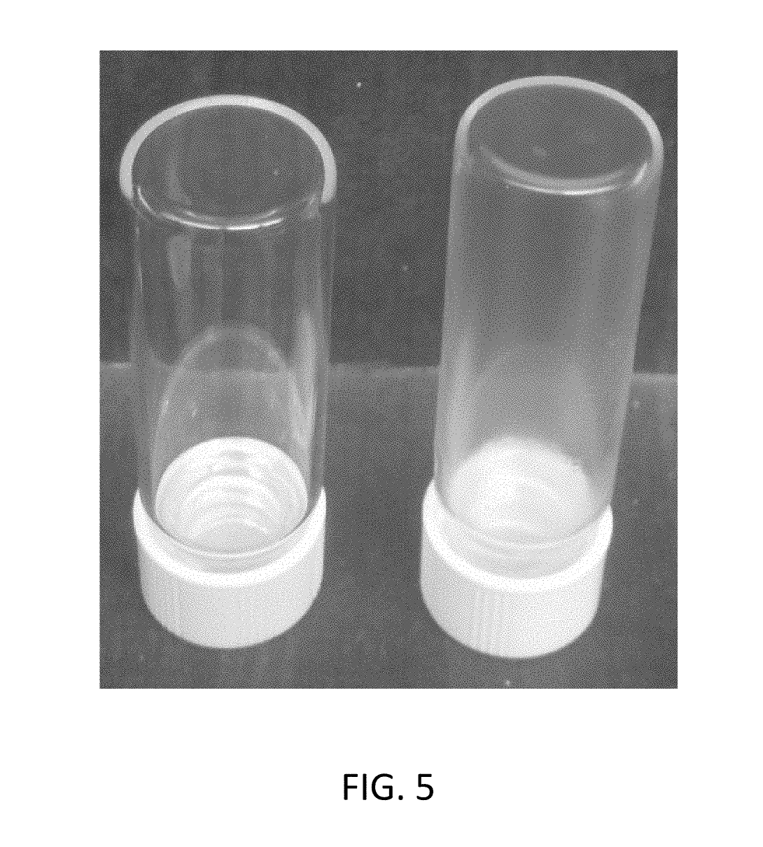

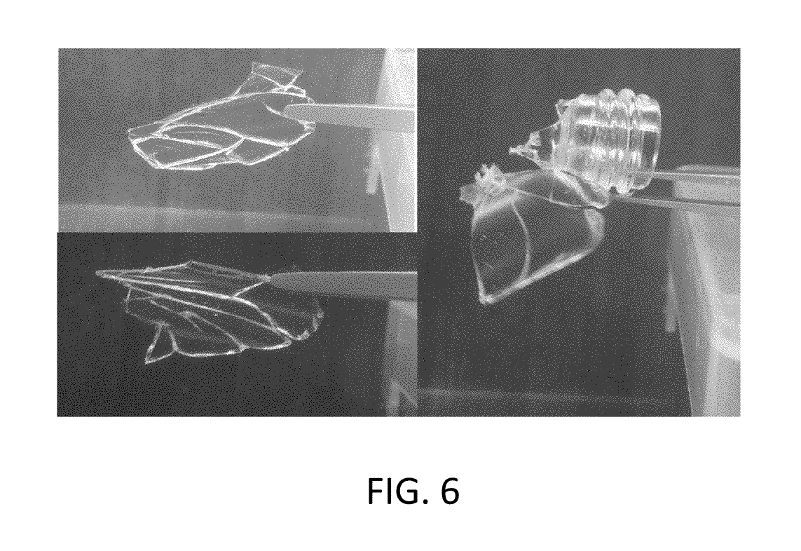

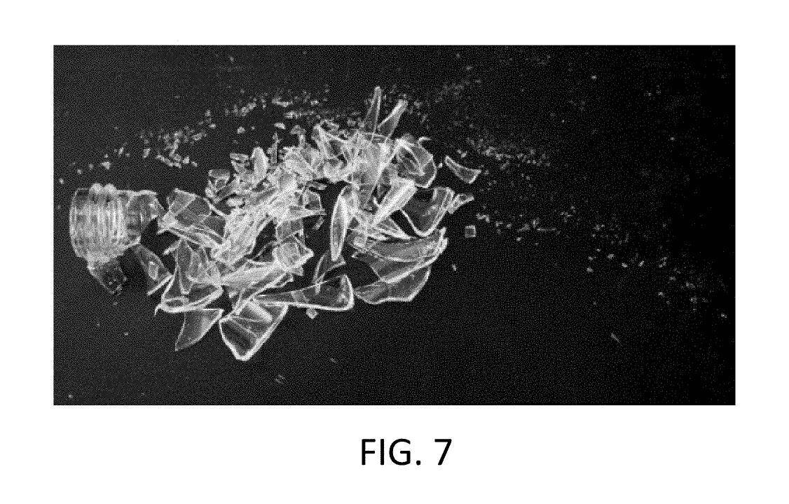

Further experiments were conducted by coating and crosslinking small glass scintillation vials. Vials were stood upright and exposed to light for 30 seconds, then turned on their side and exposed for 30 seconds, turned 90 degrees, and exposed for 30 seconds until the entire bottle had been exposed to the UV light. After crosslinking, it was observed that the bottles possessed a roughly uniform, slightly opaque coating of the PDMS-ECHE. FIG. 5 includes photographs of a coated glass bottle (displayed on the left) and an uncoated glass bottle (displayed on the right). Bottles are roughly 0.5 inches in diameter. The glass bottles were used to investigate the coatings ability to provide some degree of shatter resistance. To test such ability, a coated bottle was subjected to a rapidly applied blunt force (by placing the bottle in a plastic bag and striking it with a pipe wrench). The results were that the bottle did not resist shattering. However, the bottle broke into a number of large pieces that remained intact despite being cracked. This result shows that, despite the need for optimization, the photocurable polymer system studied demonstrate that they can serve as protective coating for glass. Such protection can be enhanced by determining optimum coating thicknesses and light exposure times to achieve mechanically robust coatings. FIG. 6 are photographs of the coated bottle post the application of the blunt force. FIG. 7 is a photograph of an uncoated bottle post the application of a blunt force.

To test the effects of varying coating thickness and cure time, 2% solutions by weight of PC 1467 and PDMS-ECHE were mixed in glass scintillation vials via vigorous stirring with a glass rod, pipetted onto 2 inch glass slides, and spread across the slide. Pipetted volumes were 2 mL, 1 mL, 0.5 mL, 0.3 mL, 0.25 mL, or 0.1 mL. Samples were placed 1 inch from the 254 nm UV light source. Curing time varied from 20-90 seconds in 10 second increments. Samples were tested in duplicate.

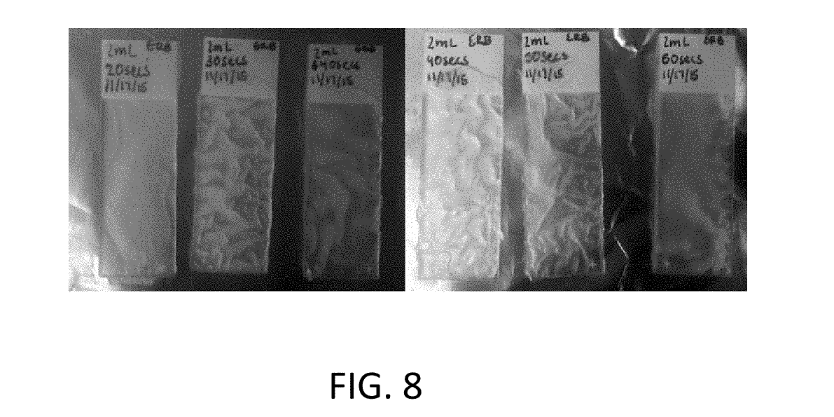

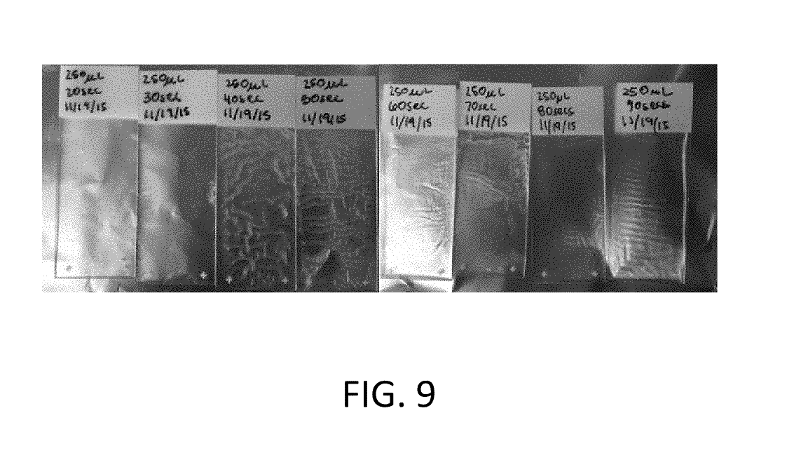

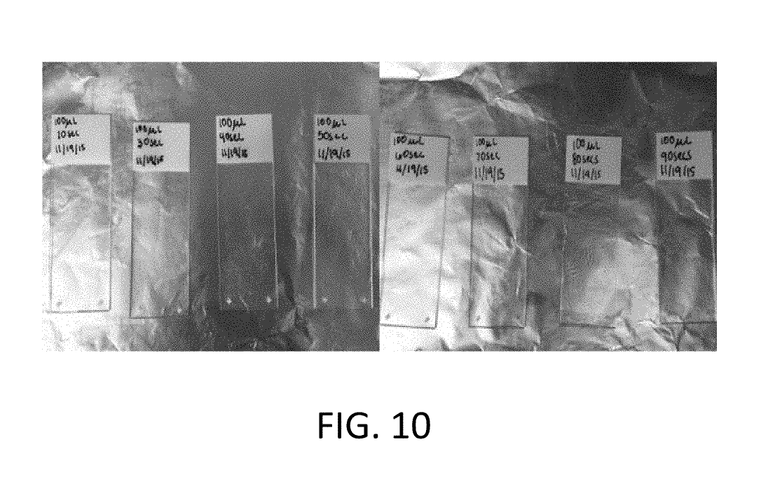

Of the samples tested, the best results were found using less material, with 0.1 and 0.25 mL samples yielding the most complete curing without becoming flaky or brittle. In samples of higher volume, primary issues were surfaces that buckled up and became wavy, incomplete curing and skin layer formation, unacceptable surface tack, and brittleness as a result of over-curing. The 0.1 mL and 0.25 mL samples in the 30, 40 and 50 second cure times were flat, mostly clear, and could be removed for further mechanical testing. FIG. 8 includes photographs of 2 mL samples with curing times ranging from 20 seconds to 60 seconds (with the leftmost sample a 20 second sample, next a 30 second sample, next two 40 second samples, next a 50 second sample, and the rightmost sample a 60 second sample); FIG. 9 includes photographs of 0.25 mL samples with curing times ranging from 20 seconds to 90 seconds (in 10 second increments, with the leftmost sample a 20 second sample and the rightmost sample a 90 second sample); and FIG. 10 includes photographs of 0.1 mL samples with curing times ranging from 10 seconds to 90 seconds (with leftmost sample a 10 second sample, next a 30 second sample, with samples proceeding in 10 second increments with the rightmost sample a 90 second sample).

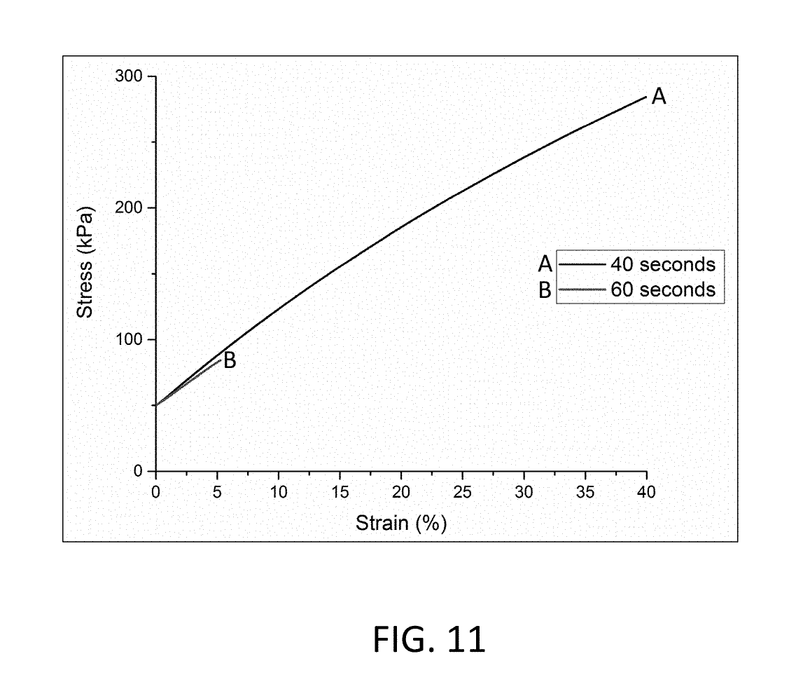

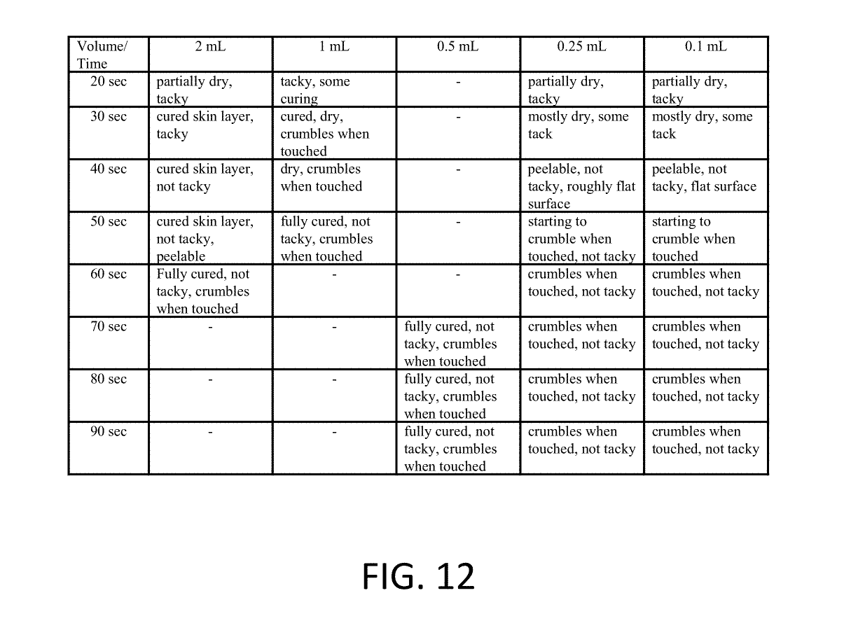

The results of the 2 mL samples included uneven spreading and uneven curing. The 2 mL samples also demonstrated some opacity. The 0.25 mL samples demonstrate generally uniform post-cure coatings, with certain instances of non-uniformity. The 0.25 mL samples cured for more than 60 seconds demonstrated some browning. The 0.1 mL samples demonstrated good uniformity, good curing, good optical clarity, and no bunching or burning. The 0.1 mL samples demonstrated generally good mechanical robustness when peeled off the slides and handled. Two 0.1 mL samples were selected for tensile testing, one cured for 40 seconds and one cured for 60 seconds. FIG. 11 illustrates the results (with curve labeled A as the 40 second sample and the curve labeled B as the 60 second sample). The cure time has an effect on the mechanical properties of the material, as the sample cured at 40 seconds reached roughly 40% strain, and the sample cured for 60 seconds reaches 5% strain. Such results illustrate that the system is tunable (i.e., preparation method can be selected to achieve desirable properties). A table with results is provide as FIG. 12.

As described herein, testing with bottles coated with the photocurable polymer system disclosed herein demonstrates that when the bottles are exposed to extreme crushing force the bottles remain partially intact. One feature of this system is the ability to vary UV exposure time and volume and achieve different properties for the coating. Monitoring of UV exposure time can optimize the coating based on the intended use for different applications. It is also possible to synthesize silicones with fewer epoxy side groups such that elastomeric properties remain at full cure, thus obviating the need to carefully control the cure time and light intensity. It is possible to shift the wavelength of light for curing to the visible region using photo-sensitizers, one being curcumin (see J. V. Crivello and U. Bulut, “Curcumin: A Naturally-Occurring Long Wavelength Photosensitizer for Diaryl Iodonium Salts,” J. Polym. Sci. Pt. A Polym. Chem., 43, 5217 (2005), which is fully incorporated herein by reference). An especially appealing application of such a system is as a coating for light bulbs to provide impact resistance toward breakage and, if breakage does occur, to confine the broken pieces. A visible light-sensitized coating could be applied and then cured by turning the bulb on for a few seconds.

Additionally, the diaryl iodonium salt photocuring system disclosed herein can be adapted to other polymers, be they highly elastomeric rubbers with reactive side groups or slightly more rigid polymers, depending on the needs of the coated product. Overall, the arrangements disclosed herein illustrate the promise of the diaryl iodonium salt/silicone epoxy elastomer system as a new method for coating materials that can be scaled-up for industrial use.

Elastomeric coatings derived from onium salt photocrosslinking can have wide applicability, even beyond impact-absorbing coatings for glass. For example, there is a need for a more versatile method of patterning hydrophilic surfaces with hydrophobic regions for two dimensional microfluidics, sometimes called surface-tension-confined microfluidics. Currently, patterning is done principally by thick-film printing and ink-jet printing. “Photo-printing” through a mask would be a very desirable option that is rapid and low-cost. Paper-based microfluidics represents another opportunity. Here, standard cellulose-based paper is employed to wick water-based analytes through paths typically defined by wax. Photocurable alternatives would not only offer fast cure times but also the ability to pattern paper through a mask.

An additional application is the selective patterning of a polymer hydrogel for asymmetric swelling in water for soft robotic and related applications. Yet another application is as a photo-elastic material, wherein liquid resin precursor with photoinitiator is applied to the surface of material which will undergo mechanical deformation. Stress transferred to the coating can, under crossed polarizing films, be revealed via induced double refraction (birefringence). Of particular interest for photocurable coatings is the ability to coat complex surfaces using a low-viscosity liquid resin precursor followed by light-induced cure, which can be accomplished with a portable light source and applied across complex shapes.

The simplicity of deposition and speed of curing for this system also makes it attractive for use for other applications, such as in additive manufacturing processes. Common, low-resolution 3D printers tend to deposit layers that are roughly 0.25 mm in thickness. Though these devices tend to require more rapid set times than can be achieved by the materials in this investigation, the possibility of using the photocuring system described in this proposal to print elastomeric materials makes investigation into this realm worth pursuing.

While epoxy-functionalized silicones materials were described herein, other epoxy-functionalized pre-polymers can be used, such as various vinyl ether-containing materials, and epoxy-terminated rubbers such as butadiene-nitrile rubber (ETBN).

Additional coating materials have been tested for use as photocurable polymer systems. One example is a PDMS-ECHE-based polymer with an additional silicone produced by Evonik Industries named TEGO RC 1401. Another example is a PDMS-ECHE-based polymer with an additional silicone produced by Evonik Industries named TEGO RC 1412. In both instances, the PDMS:ECHE ratio is altered. An additional system uses Hypro 1300X44 ETBN, an epoxy-terminated nitrile butadiene material produced by Emerald Performance Materials. The viscoelastic properties of the system can be tuned by blending these materials in different ratios, as well as by varying cure times and coating thicknesses. Also, the introduction of an epoxy-terminated nitrile butadiene material demonstrates that useful systems can be created beyond siloxane-based polymers.

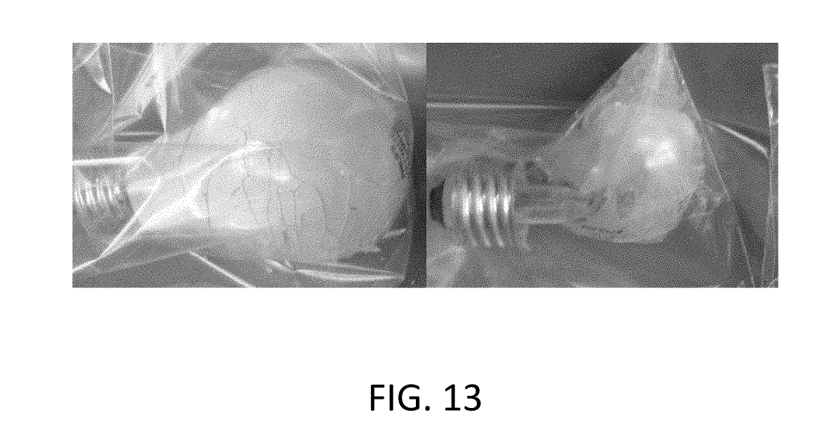

Photocurable polymer systems were tested by coating light bulbs. A light bulb coated in a 1:1 mixture of PDMS-ECHE and TEGO RC 1401. This blend was crosslinked using a UVC source by adding 0.5% by weight of PC 1467. As illustrated in FIG. 13, when dropped from a height of 10 feet, the coated lightbulb (on the left) cracked but remained mostly intact, while an untreated lightbulb (on the right) dropped from the same height shattered upon impact. In addition to adding important impact resistance, the material cured in roughly thirty seconds and remained totally clear, not imparting any color or opacity on the bulb itself. Though it is necessary to optimize the system to ensure no bulb damage, or totally contained bulb damage, this test showed that the coating system disclosed herein could see application as a “bumper coating” for glass and other materials.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

What is claimed is:

1. A method of forming a photocurable polymer system comprising:
providing a polymer;
providing a diaryl iodonium salt;
blending said polymer and diaryl iodonium salt;
applying the blend to a substrate; and
crosslinking the blend.

2. The method of claim 1, wherein the polymer is a silicone-based polymer.

3. The method of claim 2, wherein the silicone-based polymer is PDMS-ECHE.

4. The method of claim 1, wherein the blend is crosslinked by exposing the blend to ultraviolet light.

5. The method of claim 4, wherein the wavelength of the ultraviolet light is 254 nm.

6. The method of claim 4, wherein the blend is exposed to ultraviolet light for between about 10 seconds and 90 seconds.

7. The method of claim 6, wherein the blend is exposed to ultraviolet light for between about 30 seconds and 40 seconds.

8. The method of claim 4, wherein the crosslinking is cationic crosslinking.

9. The method of claim 1, wherein the blend is two percent by weight of the diaryl iodonium salt to the polymer.

10. The method of claim 1, wherein the polymer is ETBN.
